(19) United States
(12) Patent Application Publication
(10) Pub. No.: US 2010/0315459 A1
(43) Pub. Date: Dec. 16, 2010

(54) METHOD FOR PRINTING ON A CURVED SURFACE

(75) Inventors: YUAN-PING CHANG, Tu-Cheng (TW); CHING-HO WEI, Tu-Cheng (TW); LI-CHI PAI, Tu-Cheng (TW); CHANG-CHIN WU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/684,050

(22) Filed: Jan. 7, 2010

(30) Foreign Application Priority Data
Jun. 10, 2009 (CN) 200910147633.4

(51) Int. Cl. B41J 29/38

(52) U.S. Cl. 347/16

(57) ABSTRACT

A method for printing on a curved surface includes determining if a surface of a workpiece is curved, cutting an image to be printed into at least two printing areas if the surface is curved, and printing the printing area of the image on each surface of the workpiece. If the surfaces of the workpiece are not curved, the printing system directly prints the image on the workpiece. The printing system includes a rotating mechanism and a printer including an inkjet head having a plurality of nozzles. The workpiece is positioned on the rotating mechanism. The rotating mechanism rotates each surface of the workpiece to face the inkjet head and the inkjet head prints each printing area on it.

### BACKGROUND

1. Technical Field

The disclosure generally relates to printing systems, and particularly to a method for printing on a curved surface.

2. Description of Related Art

Computer printers generally work with sheet media such as paper or transparencies. Distances from ink nozzles of the printer to the printing surface are constant because the printing surface of the paper is planar.

The typical printer cannot print on three-dimensional surfaces, due to the varying distance from nozzles of the printer to the printing surface. This results in image distortion and generally poor print quality.

What is needed, therefore, is a method for printing on a curved surface addressing the limitations described.

### BRIEF DESCRIPTION OF THE DRAWINGS

FIG. 1 is a perspective view of one embodiment of a printing system employing one embodiment of a method for printing on a curved surface.

FIG. 2 is a block diagram of one embodiment of a method for printing on a curved surface.

FIG. 3 is a sectional view of the printing system of FIG. 1.

FIG. 4 is a diagram of a printing scope of the printing system of FIG. 1.

### DETAILED DESCRIPTION OF THE EMBODIMENTS

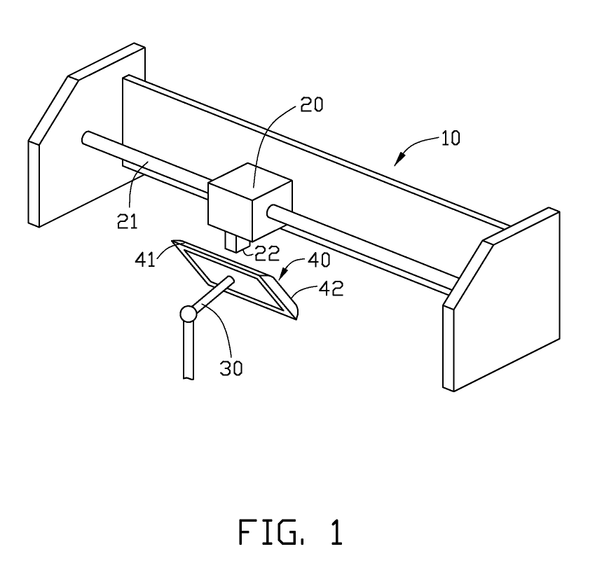

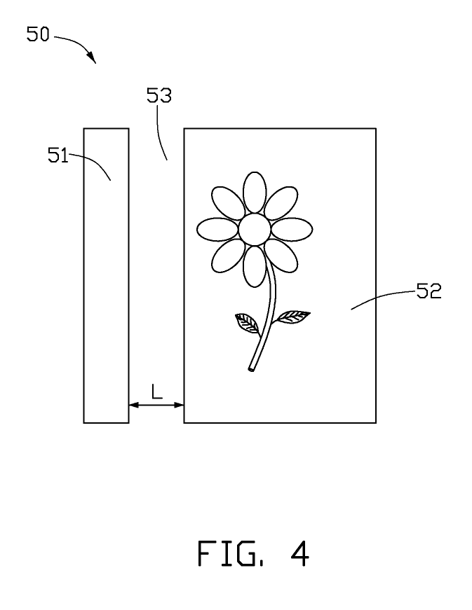

Referring to FIG. 1, a printing system 10 employing one embodiment of a method of printing on a curved surface, includes a printer (not labeled) and a rotating mechanism 30. The printer includes an inkjet head 20 having a plurality of nozzles 22 and a slide rail 21. The inkjet head 20 is on a slide rail 21, allowing it to move laterally to print an image 50 (as FIG. 4 shows) on surfaces of a workpiece 40. The workpiece 40 includes a first surface 41 and a second surface 42 to be printed on. Here, the first surface 41 is a curved surface and the second surface 42 is planar. The workpiece 40 is positioned on the rotating mechanism 30. The rotating mechanism 30 is configured for rotating the first surface 41 or the plane surface 42 of the workpiece 40 to face the inkjet head 20.

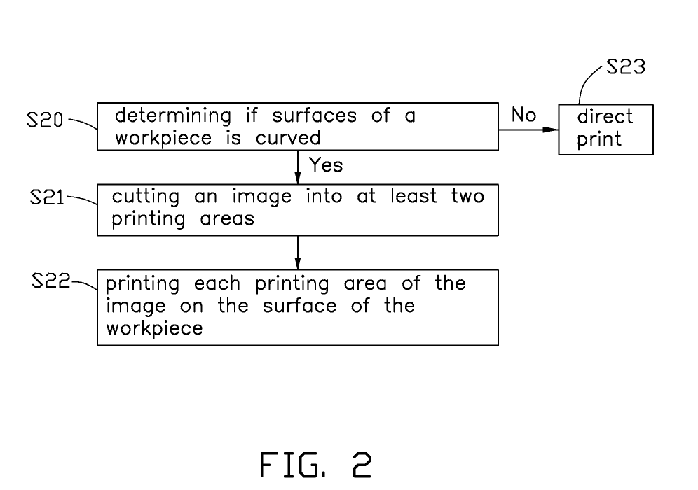

Referring to FIG. 2, the method includes the following.

In step S20, a surface of the workpiece 40 is selected. If the selected surface of the workpiece is curved, the method continues to step 21, and the selection of the curved surface of the workpiece 40 is confirmed. If the surface of the workpiece is not curved, the method continues to step 23, and direct printing begins.

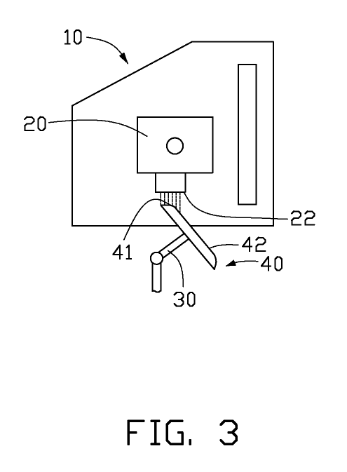

In step S21, the image is separated into at least two printing areas. Referring to FIG. 3, if the first surface 41 and the second surface 42 are printed in the same process, the first nozzle prints on the first surface 41, and the last nozzle prints on the second surface 42. Referring to FIG. 4, the image 50 is cut into at least two printing areas 51, 52 corresponding to the first surface 41 and the second surface 42, respectively. A buffer area 53 is positioned between the two printing areas 51, 52. A width L of the buffer area 53 is greater than the distance of the first nozzle to the last nozzle of the inkjet head 20. The distances from multiple nozzles 22 of the printing head 20 to each surface of the workpiece 40 may be almost constant. The image 50 can be cut into several printing areas according to different surfaces of the workpiece 40.

In Step S22, each printing area of the image is printed on each surface of the workpiece. For example in the illustrated embodiment, the rotating mechanism 30 rotates the first surface 41 of the workpiece 40 to face the inkjet head 20. The inkjet head 20 of the printing system 10 prints one printing area 51 of the image 50 on the first surface 41 of the workpiece 40. The rotating mechanism 30 rotates the second surface 42 of the workpiece 40 to face the inkjet head 20. The inkjet head 20 of the printing system 10 prints the other printing area 52 of the image 50 on the second surface 42 of the workpiece 40. The buffer area 53 is positioned between the two printing areas 51, 53 because the image 50 is cut into at least two printing areas 51, 52 corresponding to the first surface 41 and the second surface 42.

In Step S23, printing commences. The inkjet head 20 of the printing system 10 directly prints the image on the workpiece 40. The first surface 41 and the second surface 42 are printed in different printing processes, so that the nozzles can be properly positioned, resulting in a good three-dimensional printing quality.

It should be noted that the image 50 can be cut into multiple printing areas according to different surfaces of the workpiece 40. The rotating mechanism 30 rotates each surface of the workpiece 40 to face the inkjet head 20 and the inkjet head 20 prints on each printing area.

It is to be understood that the present disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for printing on a curved surface, the method comprising:
providing a printing system;
determining if surfaces of a workpiece is curved;
cutting an image into at least two printing areas; and
printing each printing area of the image on the surface of the workpiece.

2. The method as claimed in claim 1, wherein if the surfaces of the workpiece are not curved, the printing system prints the image on the surfaces of the workpiece.

3. The method as claimed in claim 1, wherein if at least one of the surfaces of the workpiece is curved, the at least one curved surface comprises a first surface and a second surface, according to which the at least two printing areas of the image are cut.

4. The method as claimed in claim 3, wherein the first surface and the second surface are printed in different printing processes.

5. The method as claimed in claim 1, wherein the printing system comprises a rotating mechanism and a printer comprising an inkjet head having a plurality of nozzles; the workpiece is positioned on the rotating mechanism; the rotating mechanism rotates the surfaces of the workpiece to face the inkjet head.

6. The method as claimed in claim 5, wherein a buffer area is positioned between the two printing areas, a width of the buffer area is greater than the distance between the first nozzle and the last nozzle of the inkjet head.

7. The method as claimed in claim 5, wherein distances from the nozzles of the printing head to each surface of the workpiece are approximately the same.
